(19) United States
(12) Patent Application Publication
(10) Pub. No.: US 2007/0281234 A1
(43) Pub. Date: Dec. 6, 2007

(54) ELECTROSTATIC CHARGE IMAGE DEVELOPING TONER

(75) Inventors: Kazuya ISOBE, Tokyo (JP); Kouji SUGAMA, Tokyo (JP); Hidemasa SAWADA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/733,492

(22) Filed: Apr. 10, 2007

(30) Foreign Application Priority Data
Jun. 5, 2006 (JP) JP2006-155797

(51) Int. Cl. G03G 9/00

(52) U.S. Cl. 430/109.1; 430/110.1

(57) ABSTRACT

An objective is to provide a toner capable of obtaining clear prints with no image unevenness at low cost. Disclosed is an electrostatic charge image developing toner comprising toner particles each containing at least a binder resin, a colorant and wax, wherein a ratio {(S1/S)×100} of total area (S1) of peaks detected in a range of 36-42 ppm to total area (S) of peaks detected in a range of 0-50 ppm, in a spectrum obtained via measurement of the wax employing a 13C-NMR (nuclear magnetic resonance) measuring apparatus, satisfies the following inequality. 0.03≦(S1/S)×100≦0.50.

This application claims priority from Japanese Patent Application No. 2006-155797 filed on Jun. 5, 2006, which is incorporated hereinto by reference.

### TECHNICAL FIELD

The present invention relates to an electrostatic charge image developing toner containing a resin, a colorant and a releasing agent.

### BACKGROUND

Along with the process of digital techniques, precise image reproduction of microdot images at a level of 1200 dpi (dpi: the number of dots per inch or 2.54 cm) has been required in the field of electrophotographic image forming techniques, such as for copiers and printers. Particle size reduction of an electrostatic charge image developing toner (hereinafter, simply referred to also as toner) has been studied in order to precisely reproduce such the microdot images. Accordingly, attention has been focused on a polymerization toner capable of making various adjustments at the preparation stage, and preparation of the toner having a small diameter capable of reproducing microdot images has become possible (refer to Patent Document 1, for example)

It is demanded to improve image unevenness in the print-on-demand market in which the print itself is worth, in addition to improved dot reproduction via particle size reduction of the toner.

Specifically, there is a technique in which image unevenness is improved by attaching a transparent toner to the entire transfer sheet to form a transparent resin layer (refer to Patent Document 2, for example). Further, there are a technique by which surface roughness of a fixed layer formed with the transparent toner is controlled, and also a technique in which a transparent resin layer is formed with nonspherical transparent toner after forming images with spherical colored toner (refer to Patent Document 4, for example). Furthermore, there is a technique in which a transparent toner is added onto a toner image or its periphery to obtain a silver halide photographic image having no image unevenness (refer to Patent Document 5, for example).

In this way, prints having no image unevenness were easily to be obtained by forming an even toner layer on a transfer sheet employing a transparent toner.

However, the resulting prints have been very expensive since not only regular 4 color toners are employed, but also a large amount of transparent toner is consumed, though it is useful to form a transparent toner layer on an image in order to clearly improve image unevenness. Thus, demanded has been an inexpensive toner capable of producing clear prints having no image unevenness.

On the other hand, reduction of time consumed before print output is desired in the print-on-demand market, and a low temperature fixing property, in which temperature of a fixing device consuming a large amount of time before the print output in comparison to the print standby time is lowered, is raised as a problem.

(Patent Document 1) Japanese Patent O.P.I. Publication No. 2000-214629

(Patent Document 2) Japanese Patent O.P.I. Publication No. 11-7174

(Patent Document 3) Japanese Patent O.P.I. Publication No. 2001-305816

(Patent Document 4) Japanese Patent D.P.I. Publication No. 2002-236392

(Patent Document 5) Japanese Patent O.P.I. Publication No. 2005-99122

### SUMMARY

It is an object of the present invention to provide not only an inexpensive toner by which prints having no image unevenness are obtained, but also a toner exhibiting excellent separation in fixing during fixation at low temperature.

### DESCRIPTION OF THE PREFERRED EMBODIMENTS

The above object of the present invention is accomplished by the following structures.

(Structure 1) An electrostatic charge image developing toner comprising toner particles each containing at least a binder resin, a colorant and wax, wherein a ratio {(S1/S)×100} of total area (S1) of peaks detected in a range of 36-42 ppm to total area (S) of peaks detected in a range of 0-50 ppm, in a spectrum obtained via measurement of the wax employing a ¹³C-NMR (nuclear magnetic resonance) measuring apparatus, satisfies the following inequality.

0.03≦(S1/S)×100≦0.50

(Structure 2) The electrostatic charge image developing toner of Structure 1, wherein the ratio {(S1/S)×100} satisfies the following inequality.

0.05≦(S1/S)×100≦0.30

(Structure 3) The electrostatic charge image developing toner of structure 1, wherein the wax is hydrocarbon based wax.

(Structure 4) The electrostatic charge image developing toner of structure 2, wherein the wax is hydrocarbon based wax.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

The present invention will further be described in detail.

It is found out in the present invention that clear prints having no image unevenness are obtained in the case of utilizing an electrostatic charge image developing toner comprising toner particles each containing at least a binder resin, a colorant and wax, wherein a ratio {(S1/S)×100} of total area (S1) of peaks detected in a range of 36-42 ppm to total area (S) of peaks detected in a range of 0-50 ppm, in a spectrum obtained via measurement of the wax employing a 13C-NMR (nuclear magnetic resonance) measuring apparatus, is 0.03-0.50, and preferably 0.05-0.30. S1 is originated from a tertiary carbon atom and a quarternary carbon atom contained in a wax molecule. This means that wax is not composed of a straight chain structure, but of a branched chain structure. In the case of the ratio {(S1/S)×100} of at most 0.03, image unevenness is generated since crystallinity of the wax is increased. In the case of the ratio {(S1/S)×100} of at least 0.50, separability in fixing is deteriorated since viscosity of the wax is increased because of an increased amount of the branched chain structure.

In order to realize a toner capable of producing clear prints having no image unevenness at low cost for users, the inventors have studied design of a releasing agent layer formed on the image surface. That is, a toner capable of generating no image unevenness via contact fixation with a thermal roller, a thermal belt or such has been studied by focusing on the toner image surface after fixing.

When the ratio of the total area of peaks detected in a range of 36-42 ppm to the total area of peaks detected in a range of 0-50 ppm, in a spectrum obtained via measurement of the wax employing a 13C-NMR (nuclear magnetic resonance) measuring apparatus satisfies the foregoing relationship, it is found out that image unevenness on the toner image surface after fixing is improved. The reason why effects of the present invention are produced by what is mentioned above is not clear, but it is assumed that prints having no image unevenness are possible to be obtained by utilizing wax having a specific structure, since crystallinity of the wax is closely associated with the image unevenness.

Next, the present invention will be explained in detail.

Toner of the present invention is an electrostatic charge image developing toner comprising toner particles each containing at least a binder resin, a colorant and wax, and as to a spectrum obtained via measurement of the wax employing a 13C-NMR (nuclear magnetic resonance) measuring apparatus, a ratio {(S1/S)×100} of total area (S1) of peaks detected in a range of 36-42 ppm to total area (S) of peaks detected in a range of 0-50 ppm, is 0.03-0.50, and preferably 0.05-0.30. That is, it is found out that prints having no image unevenness together with separability in fixing maintained at low temperature can be obtained when images are formed with the toner containing wax which satisfies the above-described relationship.

Although the precise cause is as yet not well known, it is assumed that prints having no image unevenness are obtained when crystallinity of wax is in an appropriate region, since image unevenness is closely associated with the crystallinity of wax.

In this way, it was found out in the present invention that prints having no image unevenness were obtained in the specific relationship by focusing on wax contained in the toner.

Under the following conditions, ¹³C-NMR of wax constituting toner of the present invention can be measured.

### [Condition of 13C-NMR Measuring Method]

Measuring apparatus: FT NMR spectrometer Lambda 400 (produced by Nippon Denshi Co., Ltd.)

Measuring frequency: 100.5 MHz

Pulse condition: 4.0 μs

Data point: 32768

Delay time: 1.8 sec

Frequency range: 27100 Hz

The number of integratings: 20000

Measurement temperature: 80° C.

Solvent: benzene-d6/o-dichlorobenzene-d4=1/4 (v/v)

Sample concentration: 3% by weight

Sample tube: φ5 mm

Measurement mode: 1H complete decoupling method. Incidentally, as to a spectrum obtained via measurement employing a 13C-NMR (nuclear magnetic resonance) measuring apparatus in the present invention, a ratio {(S1/S)×100} of total area (S1) of peaks detected in a range of 36-42 ppm to total area (S) of peaks detected in a range of 0-50 ppm is 0.03-0.50, and preferably 0.05-0.30.

The wax may be utilized via adjustment so as to satisfy the above-described conditions, and hydrocarbon based wax is preferable. There are, for example, usable a method in which raw oil of vacuum distillation residual oil or heavy distillates of petroleum are separated by a solvent extraction technique so as to make the condition of the present invention, and also a method of incorporating commercially available wax having a branched chain structure into wax having no branched chain structure.

Specific examples of wax having a branched chain structure include microcrystalline waxes such as HNP-0190, Hi-Mic-1045, Hi-mic-1070, Hi-Mic-1080, Hi-Mic-1090, Hi-Mic-2045, Hi-Mic-2065 and Hi-Mic-2095 (produced by Nippon Seiro Co., Ltd.) and waxes mainly containing an isoparaffin wax, such as waxes EMW-0001 and EMW-0003.

A microcrystalline wax which is one of petroleum waxes and differs from a paraffin wax which is mainly comprised of a straight chain hydrocarbon (normal paraffin), is a wax in which the proportion of branched chain hydrocarbons (iso-paraffin) and cyclic hydrocarbons (cycloparaffin) is relatively high. Generally, a microcrystalline wax, which is mainly comprised of low-crystalline isoparaffin and cycloparaffin, is composed of smaller crystals and exhibits a larger molecular weight, compared to a paraffin wax. Such a microcrystalline wax has 30-60 carbon atoms, a weight-average molecular weight of 500-800 and a melting point of 60-90° C.

A microcrystalline wax with a weight average molecular weight of 600-800 and a melting point of 60-85° C. is preferable when the microcrystalline wax is employed in the present invention. Further, a paraffin wax having a number-average molecular weight of 300-1,000 (preferably 400-800) is preferred. The ratio of weight average molecular weight to number average molecular weight (Mw/Mn) is preferably from 1.01-1.20.

Polyolefin wax such as olypropylene, polyethylene or such are provided as wax having no branched chain structure. There are paraffin wax and Fischer-Tropsch wax and so forth as a trivial name. There are also provided other types of wax having no branched chain structure out of aliphatic acid wax having 12-24 carbon atoms, an ester compound thereof, higher alcohol wax, carnauba wax and so forth.

The wax is incorporated to the toner of the present invention preferably in an amount of 1-30% by weight of a binder resin, and more preferably 5-20% by weight.

A melting point of wax constituting the toner of the present invention is 60-100° C., and preferably 65-85° C.

The melting point represents a temperature at the top of an endothermic peak of the wax, which can be determined by using, for example, DSC-7 differential scanning calorimeter (produced by Perkin Elmer, Inc.) or TAC7/DX thermal analyzer controller (produced by Perkin Elmer, Inc.).

Specifically, 4.00 mg of a releasing agent is weighed at a precision to two places of decimals and enclosed in an aluminum pan (KITNO. 0219-0041), and then set onto a DSC-7 sample holder. Temperature control of Heat-Cool-Heat is carried out, while measuring conditions of a measurement temperature of 0-200° C., a temperature-increasing speed of 10° C./min and temperature-decreasing speed of 10° C./min, and analysis was conducted based on the data of the 2nd Heat. Measurement for reference was performed using an empty aluminum pan. The temperature at the top of an endothermic peak of a releasing agent is designated as a melting point of the releasing agent.

### [Manufacturing Method of Toner]

Methods of manufacturing the toner of the present invention are not specifically limited and examples thereof include a pulverization method, a suspension polymerization method, a mini-emulsion polymerization coagulation method, an emulsion polymerization coagulation method, a solution suspension method and a polyester molecule elongation method of these methods, the mini-emulsion polymerization coagulation method is specifically preferred, in which, in an aqueous medium containing a surfactant at a concentration lower than the critical micelle concentration, a polymerizable monomer solution containing a releasing agent dissolved in a polymerizable monomer is dispersed by employing mechanical energy to form oil droplets (10-1000 nm) to prepare a dispersion; to the prepared dispersion, a water-soluble polymerization initiator is added to perform radical polymerization to obtain binder resin particles; the obtained binder resin particles were coagulated (coagulated and fused) to obtain a toner.

In the foregoing method, polymerization is performed in the form of oil droplets so that in the individual toner particles, wax molecules are definitely enclosed in the binder resin. It is therefore supposed that generation of volatile components of the releasing agent is inhibited until subjected to fixing in a fixing device or heated. An amount of wax charged as raw material is steadily contained in the toner.

In the foregoing mini-emulsion polymerization coagulation method, an oil-soluble polymerization initiator may be added to the monomer solution, in place of or concurrently with addition of the water-soluble polymerization initiator.

In the method of manufacturing the toner of the present invention, binder resin particles formed in the mini-emulsion polymerization coagulation method may be formed of at least two layers, in which to a dispersion of first resin particles prepared by mini-polymerization according to the conventional manner (the first step polymerization), a polymerization initiator and a polymerizable monomer are added to perform polymerization (the second step polymerization).

To be more specific, the mini-emulsion polymerization coagulation method, as a manufacturing method of the toner comprises:

(1) solution/dispersion step in which toner particle constituent materials such as a releasing agent, a colorant and optionally, a charge control agent are dissolved or dispersed in a polymerizable monomer to form a binder resin to obtain a polymerizable monomer solution,

(2) polymerization step in which the polymerizable monomer solution is dispersed in the form of oil-droplets dispersed in an aqueous medium and polymerized through mini-emulsion polymerization to prepare a dispersion of binder resin particles,

(3) coagulation/fusion step in which the binder resin particles are allowed to be salted out, coagulated and fused to form coagulated particles,

(4) ripening step in which the coagulated particles are thermally ripened to control the particle form to obtain a dispersion of toner particles,

(5) cooling step in which the toner particle dispersion is cooled,

(6) filtration/washing step in which toner particles are separated through solid/liquid separation from the cooled toner particle dispersion, and surfactants and the like are removed from the toner particles,

(7) drying step in which the washed toner particles are dried, and

(8) a step of adding external additives to the dried toner particles (external addition treatment). The individual steps are further detailed below.

### (1) Solution/Dispersion:

This step comprises dissolving or dispersing toner particle constituent materials such as releasing agents and colorants in a polymerizable monomer to form a polymerizable monomer solution.

The releasing agents are added in such an amount that the content of the releasing agents falls within the range described previously.

The polymerizable monomer solution may be added with an oil-soluble polymerization initiator and/or other oil-soluble components.

### (2) Polymerization:

In one suitable embodiment of the polymerization step, the foregoing polymerizable monomer solution is added to an aqueous medium containing a surfactant at a concentration lower than the critical micelle concentration and mechanical energy is applied thereto to form oil-droplets, subsequently, polymerization is performed in the interior of the oil-droplets by radicals produced from a water-soluble polymerization initiator. Resin particles as nucleus particles may be added to the aqueous medium in advance.

Binder resin particles containing reducing agents and a binder resin are obtained in the polymerization step. The obtained binder resin particles may or may not be colored. The colored binder resin particles can be obtained by subjecting a monomer composition containing a colorant to polymerization. In cases when using non-colored binder resin particles, a dispersion of colorant particles is added to a dispersion of binder resin particles, and the colorant particles and the binder resin particles are coagulated to obtain toner particles.

The aqueous medium refers to a medium that is composed mainly of water (at least 50% by weight). A component other than water is a water-soluble organic solvent. Examples thereof include methanol, ethanol, isopropanol, butanol, acetone, methyl ethyl ketone and tetrahydrofuran. Of these solvents, alcoholic organic solvents such as methanol, ethanol, isopropanol and butanol are specifically preferred.

Methods of dispersing a polymerizable monomer solution in an aqueous medium are not specifically limited but dispersion by using mechanical energy is preferred. Dispersing machines to perform dispersion by using mechanical energy are not specifically limited and examples thereof include CLEARMIX (produced by M Technique Co., Ltd.), an ultrasonic homogenizer, a mechanical homogenizer, a Manton-Gaulin homogenizer and a pressure homogenizer. The dispersed particle diameter is preferably within the range of 10-1000 nm, and more preferably 30-300 nm.

### (3) Coagulation/Fusion:

In the coagulation/fusion step, in cases when the binder resin particles are non-colored, a dispersion of colorant particles is added to the dispersion of binder resin particles, obtained in the foregoing polymerization step, and allowing the binder resin particles to be salted out, coagulated and fused with the colorant particles. In the course of the coagulation/fusion step, binder resin particles differing in resin composition may further be added to perform coagulation.

In the coagulation/fusion step, particles of internal additives such as a charge control agent may be coagulated together with binder resin particles and colorant particles.

Coagulation/fusion is performed preferably in the following manner. To an aqueous medium including binder resin particle and colorant particles, a salting-out agent composed of alkali metal salts and/or alkaline earth metal salts is added as a coagulant at a concentration of more than the critical coagulation concentration and then heated at a temperature higher than the glass transition point of the binder resin particles and also higher than the melting peak temperature of a releasing agent used therein to perform salting-out concurrently with coagulation/fusion.

In the coagulation/fusion step, it is necessary to perform prompt rise in temperature by heating and the temperature raising rate is preferably at least 1° C./min. The upper limit of the temperature raising rate is not specifically limited but is preferably at most 15° C./min in terms of inhibiting formation of coarse particles due to a rapid progress of salting-out, coagulation and fusion.

After a dispersion of binder resin particles and colorant particles reaches a temperature higher than the glass transition point of the binder resin particles and also higher than the melting peak temperature of a releasing agent, it is essential to maintain that temperature of the dispersion over a given time to allow salting-out, coagulation and fusion. Thereby, growth of toner particles (coagulation of binder resin particles and colorant particles) and fusion (dissipation of interfaces between particles) effectively proceed, leading to enhanced durability of the toner.

A dispersion of colorant particles can be prepared by dispersing colorant particles in an aqueous medium. Dispersing colorant particle is performed at a surfactant concentration in water higher than the critical micelle concentration (CMC). Dispersing machines used for dispersing colorant particles are not specifically limited but preferred examples thereof include pressure dispersing machines such as an ultrasonic disperser, a mechanical homogenizer, a Manton-Gaulin homomixer or a pressure homogenizer, and a medium type dispersing machines such as a sand grinder, a Gettsman mil or a diamond fine mill.

The colorant particles may be those which have been subjected to surface modification treatments. Surface modification of the colorant particles is affected, for example, in the following manner. A colorant is dispersed in a solvent and thereto, a surface-modifying agent is added and allowed to react with heating. After completion of the reaction, the colorant is filtered off, washed with the same solvent and dried to produce surface-modified colorant particles.

### (4) Ripening:

Ripening is performed preferably by using thermal energy (heating).

Specifically, a system including coagulated particles is stirred with heating, while controlling the heating temperature, a stirring speed and heating rate until the shape of toner particles reaches the intended average circularity.

In the ripening step, the toner particles obtained above may be used as core particles and binder resin particles are further attached and fused onto the core particles to form a core/shell structure. In that case, the glass transition point of binder resin particle constituting the shell layer is preferably higher by at least 20° C. than that of binder resin particles constituting the core particles.

When binder resin particles used in the coagulation/fusion step are composed of a resin made from a polymerizable monomer containing an ionically dissociative group (hydrophilic resin) and a resin made from a polymerizable monomer containing no ionically dissociative group (hydrophobic resin), toner particles having a core/shell structure may be formed by disposing the hydrophilic resin on the surface side of the coagulated particle and the hydrophobic resin in the inside of the coagulated particle.

### (5) Cooling:

This step refers to a stage that subjects a dispersion of the foregoing toner particles to a cooling treatment (rapid cooling). Cooling is performed at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

### (6) Filtration/Washing:

In the filtration and washing step, a solid-liquid separation treatment of separating toner particles from a toner particle dispersion is conducted, then cooled to the prescribed temperature in the foregoing step and a washing treatment for removing adhered material such as a surfactant or salting-out agent from a separated toner particles (aggregate in a cake form) is applied.

In this step, washing is conducted until the filtrate reaches a conductivity of 10 uS/cm. A filtration treatment is conducted, for example, by a centrifugal separation, filtration under reduced pressure using a Nutsche funnel or filtration using a filter press, but the treatment is not specifically limited.

### (7) Drying:

In this step, the washed toner cake is subjected to a drying treatment to obtain dried colored particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried toner particles is preferably not more than 5% by weight, and more preferably not more than 2%. When toner particles that were subjected to a drying treatment are aggregated via a weak attractive force between particles, the aggregate may be subjected to a pulverization treatment. Pulverization can be conducted using a mechanical pulverizing device such as a jet mill, Henschel mixer, coffee mill or food processor.

### (8) External Additive Addition:

In this step, the dried colored particles are optionally mixed with external additives to prepare a toner. There are usable mechanical mixers such as a Henschel mixer and a coffee mill.

### [Binder resin]

Commonly known various resins, for example, vinyl resin such as styrene resin, (meth)acryl resin, styrene-(meth)acryl copolymer resin and olefinic resin, polyester resin, polyamide resin, polycarbonate resin, polyether resin, poly(vinyl acetate) resin, polysulfone resin, epoxy resin, polyurethane resin, and urea resin are used, as a binder resin constituting the toner of the present invention, in toner particles manufactured by a pulverization method or a solution suspension method. These resins can be used singly or in combination.

In the case of producing toner particles constituting toner of the present invention by a suspension polymerization method, a mini-emulsion-polymerization-coagulation method, an emulsion-polymerization-coagulation method or such, examples of the polymerizable monomer to acquire each resin constituting the toner include vinyl based monomers of:

styrene or a styrene derivative such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene or p-n-dodecylstyrene;

a methacrylic acid ester derivative such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate or dimethylaminoethyl methacrylate;

an acrylic acid ester derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate or phenyl acrylate;

olefin such as ethylene, propylene or isobutylene; vinyl halide such as vinyl chloride, vinylidene chloride, vinyl bromide, vinyl fluoride or vinylidene fluoride;

vinyl ester such as vinyl propioniate, vinyl acetate o vinyl benzoate;

vinyl ether such as vinylmethyl ether or vinylethyl ether; vinyl ketone such as vinylmethyl ketone, vinylethyl ketone or vinylhexyl ketone;

a N-vinyl compound such as N-vinyl carbazole, N-vinyl indole or N-vinyl pyrrolidone; a vinyl compound such as vinyl naphthalene or vinyl pyridine; and

an acrylic acid or a methacrylic acid derivative such as acrylonitrile, methacrylonitrile or acrylamide.

These vinyl based monomer are usable singly or in combination with at least two kinds.

Further, these are preferably used as a polymerizable monomer in combination with those having an ionic dissociation group. Polymerizable monomers having an ionic dissociation group are those having a substituent such as a carboxyl group, a sulfonate group or a phosphate group as a constituting group. Examples thereof include an acrylic acid, a methacrylic acid, a maleic acid, an itaconic acid, a cinnamic acid, a fumaric acid, maleic acid monoalkylester, itaconic acid monoalkyl ester, styrene sulfonic acid, alylsulfo citric acid, 2-acrylamide-2-methylpropane sulfonic acid, acid phosphooxyethyl methacrylate and 3-chloro-2-acid phosphooxypropyl methacrylate. In addition, a resin having a crosslinking structure can also be obtained by utilizing as a polymerizable monomer multifunctional vinyls such as divinylbenzene, ethyleneglycol dimethacrylate, ethyleneglycol diacrylate, diethylene glycol dimethacrylate, diethylene glycol diacrylate, triethylene glycol dimethacrylate, triethylene glycol diacrylate, neopentyl glycol dimethacrylate and neopentyl glycol diacrylate.

### [Surfactant]

In manufacturing the toner particles of the present invention by the suspension polymerization method, a mini-emulsion polymerization coagulation method or emulsion polymerization coagulation method, surfactants used for obtaining a binder resin are not specifically limited but ionic surfactants described below are suitable. Such ionic surfactants include sulfates (e.g., sodium dodecylbenzenesulfate, sodium arylalkylpolyethersulfonate, sodium 3,3-disulfondisphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate) and carboxylates (e.g., sodium oieate, sodium laurate, sodium caprate, sodium caprylate, sodium caproate, potassium stearate, calcium oleate). Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid, and sorbitan ester. These surfactants are used as an emulsifying agent when manufacturing the toner by an emulsion polymerization method but may also be used in other processes or for other purposes.

### [Polymerization Initiator]

In manufacturing the toner particles of the present invention by the suspension polymerization method, a mini-emulsion polymerization coagulation method or an emulsion polymerization coagulation method, binder resin can be obtained through polymerization by using radical polymerization initiators.

Specifically, oil-soluble radical polymerization initiators are usable in suspension polymerization and examples of an oil-soluble polymerization initiator include azo- or diazo-type polymerization initiators, e.g., 2,2′-azobis-(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile, azobisisobutylonitrile; peroxide type polymerization initiators, e.g., benzoyl peroxide, methyl ethyl ketone peroxide, diisopropylperoxycarbonate, cumene hydroperoxide, t-butyl hyroperoxide, di-t-butyl peroxidedicumyl peroxide, 2,4-dichlorobenzoyl peroxide, lauroyl peroxide, 2,2-bis-(4,4-t-butylperoxycyclohexyl)-propane, tris-(t-butylperoxy)triazine; and polymeric initiators having a side-chain of peroxide.

Water-soluble radical polymerization initiators are usable in a mini-emulsion polymerization coagulation method or an emulsion polymerization coagulation method. Examples of a water-soluble polymerization initiator include persulfates such as potassium persulfate and ammonium persulfate; azobisaminodipropane acetic acid salt, azobiscyanovaleric acid and its salt, and hydrogen peroxide.

### [Chain Transfer Agent]

In manufacturing the toner particles of the present invention by the suspension polymerization method, a mini-emulsion polymerization coagulation method or an emulsion polymerization coagulation method, generally used chain transfer agents are usable for the purpose of controlling the molecular weight of a binder resin. Chain transfer agents are not specifically limited, but examples thereof include mercaptans such as n-octylmercaptan, n-decylmercaptane and tert-dodecylmercaptan; n-octyl-3-mercaptopropionic acid ester, terpinolene, carbon tetrabromide, carbon and α-methylstyrene dimmer.

### [Colorant]

Commonly known inorganic or organic colorants are usable for the toner of the present invention. Specific colorants are as follows.

Examples of black colorants include carbon black such as Furnace Black, Channel Black, Acetylene Black, Thermal Black and Lamp Black and magnetic powder such as magnetite and ferrite.

Magenta and red colorants include C.I. Pigment Red 2, C.I. Pigment Red 3, C.I. Pigment Red 5, C.I. Pigment Red 16, C.I. Pigment Red 48, C.I. Pigment Red 53, C.I. Pigment Red 57, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Orange or yellow colorants include C.I. Pigment Orange 31, C.I. Pigment Orange43, C.I. Pigment Yellow 12, C.I. Pigment Yellow 13, C.I. Pigment Yellow 14, C.I. Pigment Yellow 15, C.I. Pigment Yellow 74, C.I. Pigment Yellow 93, C.I. Pigment Yellow 94, C.I. and Pigment Yellow 138.

Green or cyan colorants include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66 and C.I. Pigment Green 7.

The foregoing colorants may be used singly or in combination with at least two kinds.

The colorant content is preferably 1-30% by weight, and more preferably 2-20% by weight.

Surface-modified colorants are also usable. Commonly known surface modifiers are usable and preferred examples thereof include a silane coupling agent, a titanium coupling agent and an aluminum coupling agent.

### [Coagulant]

Coagulants usable in manufacturing the toner particles of the present invention by a mini-emulsion polymerization coagulation method or an emulsion polymerization coagulation method include, for example, alkali metal salts and alkaline earth metal salts. Alkali metals constituting a coagulant include, for example, lithium, sodium and potassium; alkaline earth metals constituting a coagulant include, for example, magnesium, calcium, strontium and barium. Of the foregoing, potassium, sodium, magnesium, calcium and barium are preferred. Counter-ions for the alkali metal or the alkaline earth metal (anion constituting a salt) include, for example, chloride ion, bromide ion, iodide ion, carbonate ion and sulfate ion.

### [Charge Control Agent]

The toner particles of the present invention may optionally contain a charge control agent. Charge control agents usable in the present invention include various compound commonly known in the art.

### [Toner Particle Diameter]

The toner particles of the present invention preferably have a number average particle diameter of 3-8 μm. In manufacturing toner particles by the polymerization methods described earlier, the particle diameter can be controlled by a coagulant concentration, the addition amount of organic solvents, a fusing time and polymer composition.

A number average particle diameter falling within the range of 3-8 μm not only achieves reproduction of fine lines and enhanced image quality of photographic images but can also reduce toner consumption, compared to the use of a toner of a larger particle diameter.

### [Average Circularity of Toner Particle]

The toner particles of the present invention exhibit an average circularity of 0.930-1.000, and preferably an average circularity of 0.950-0.995 in view of improvement of a transfer efficiency. The average circularity is represented by the following equation (3).

Average circularity={(circumference of a circle having an area equivalent to the projected area of a particle)/(a circumference of the projected particle)} Equation (3)

### [External Additives]

To improve flowability or charging property or to enhance cleaning capability, so-called external additives may be added to the toner of the present invention. External additives are not specifically limited, and a variety of inorganic particles, organic particles and lubricants are usable as an external additive.

Inorganic oxide particles of silica, titania, alumina and the like are preferably used for inorganic particles. The inorganic particles may be surface-treated preferably by using a silane coupling agent, titanium coupling agent and the like to enhance hydrophobicity. Spherical organic particles having an average primary particle diameter of 10-2000 nm are also usable. Polystyrene, poly(methyl methacrylate), styrene-methyl methacrylate copolymer and the like are usable as organic particles.

External additives are incorporated to the toner preferably in an amount of 0.1-5.0% by weight, and more preferably 0.5-4.0% by weight. External additives may be incorporated singly or in combination.

### [Developer]

The toner of the present invention may be used as a magnetic or nonmagnetic monocomponent developer or as a dicomponent developer together with a carrier. To be more concrete, in cases when the toner is used as a monocomponent developer, a nonmagnetic monocomponent developer and a magnetic monocomponent developer which contains magnetic particles of 0.1-0.5 μm in the toner are cited and both are usable. In cases when the toner is used as a dicomponent developer, magnetic particles composed of metals such as iron, ferrite or magnetite, or alloys of the foregoing metals and aluminum or lead are usable as a carrier, and of these, ferrite particles are specifically preferred. There may also be used a coat carrier of resin-coated magnetic particles and a resin dispersion type carrier in which a fine-powdery magnetic material is dispersed in a binder resin.

Coating resins used for the coat carrier are not specifically limited, and examples thereof include olefinic resin, styrene resin, styrene-acryl resin, silicone resin, ester resin and fluorine-containing polymer resin. Resins used for the resin dispersion type carrier are not specifically limited and commonly known ones are usable, such as styrene-acryl resin, polyester resin, fluororesin and phenol resin.

A coat carrier coated with styrene-acryl resin is cited as a preferred carrier in terms of preventing external additives from being released and durability.

The volume-based median diameter of carrier particles is preferably 20-100 μm, and more preferably 25-80 μm. The volume-based median diameter of the carrier particles can be determined using a laser diffraction type particle diameter distribution measurement apparatus provided with a wet disperser, HELOS (produced by SYMPATEC Corp.).

### [Image Forming Method]

The toner of the present invention is suitably used in an image forming method in which a toner image on a transfer material is fixed in a fixing device of a contact heating system.

### [Fixing device]

As a suitable fixing method used in the image forming method as described above is cited a so-called contact heating system. Specific examples of such a contact heating system include a thermo-pressure fixing system, a thermal roll fixing system and a pressure heat-fixing system in which fixing is performed by a fixed rotatable pressure member enclosing a heating body.

### [Transfer Material]

A transfer material to form an image of the toner of present the present invention is a support to hold a toner image. Specific examples thereof include plain paper inclusive of thin and thick paper, fine-quality paper, coated paper used for printing, such as art paper or coated paper, commercially available Japanese paper and postcard paper, plastic film used for OHP (overhead projector) and cloth, but are not limited to the foregoing.

Prints with no image unevenness can be obtained via the resulting fixed images since wax contained in the toner according to the present invention has a specific structure.

### EXAMPLE

Next, the present invention will be explained employing examples, but the present invention is not limited thereto.

### [Refining of Hydrocarbon Compound Having Specific Structure]

Raw oils of petroleum reduced-pressure distillation residue oils or heavy distillate oils were subjected to separation through a solvent extraction method to purify releasing agents 1-8 exhibiting the physical properties, as shown in Table 1. Incidentally, each of spectra was obtained via measurement of each of releasing agents 1-8 to determine each S1 and S.

TABLE 1

| Releasing agent No. | (S1/S) × 100 | Remarks |
|---|---|---|
| 1 | 0.03 | Present invention |
| 2 | 0.05 | Present invention |
| 3 | 0.10 | Present invention |
| 4 | 0.30 | Present invention |
| 5 | 0.50 | Present invention |
| 6 | 0.02 | Comparative example |
| 7 | 0.51 | Comparative example |
| 8 | 1.0 | Comparative example |

### [Preparation Example of Resin Particle Dispersion 1]

### (First Polymerization Step)

To a 5 liter reaction vessel fitted with a stirrer, a temperature sensor, a condenser and a nitrogen gas introducing device was placed 8 g of sodium dodecylsulfate dissolved in 3 liters of ion-exchange water and the internal temperature was raised to 80° C., while stirring at a stirring speed of 230 rpm under a nitrogen gas stream. After raised to the said temperature, a solution of 10 g of potassium persulfate dissolved in 200 g of ion-exchange water, then, the liquid temperature was again raised to 80° C. and a polymerizable monomer solution composed of 480 g of styrene, 250 g of n-butylacrylate, 68.0 g of methacrylic acid and 16.0 g of n-octyl 3-mercaptopropionate was dropwise added thereto over a period of 1 hr. After completion of addition, the reaction mixture was heated at 80° C. for 2 hr, with stirring to perform polymerization to prepare a resin particle dispersion (1H) containing resin particles (1 h).

### [Second Polymerization Step]

To a 5 liter reaction vessel fitted with a stirrer, a temperature sensor, a condenser and a nitrogen gas introducing device was placed 7 g of polyoxyethylene 2-dodecyl ether sodium sulfate, dissolved in 800 ml of ion-exchange water. After the internal temperature was raised to 70° C., 260 g of the foregoing resin particle dispersion (1H) and a polymerizable monomer solution of 245 g of styrene, 120 g of n-butyl acrylate, 1.5 g of n-octyl 3-mercaptopropionate, and 133 g of releasing agent 1 shown in Table 1 which were dissolved at 70° C., were added thereto and mixed with stirring for 1 hr. using a mechanical stirring machine having a circulation route, namely CLEAR MIX (produced by M Technique Co., Ltd.) to prepare a dispersion containing emulsified particles (oil droplets).

Subsequently, to this dispersion was added an initiator solution of 6 g of potassium persulfate dissolved in 200 ml of ion-exchange water and this system was heated at 82° C. with stirring over 1 hr. to perform polymerization to prepare resin particle dispersion (1HM) containing resin particles (1hm).

### (Third Polymerization Step)

To the foregoing resin particle dispersion (1HM) was added a solution of 11 g of potassium persulfate dissolved in 400 ml of ion-exchange water, and a polymerizable monomer solution of 435 g of styrene, 130 g of n-butyl acrylate, 33 g of methacrylic acid and 8 g of n-octyl-3-mercaptopropionate was dropwise added over a period of 1 hr. at 82° C. After completion of addition, stirring was continued with heating for 2 hr. to perform polymerization. Thereafter, the reaction mixture was cooled to 28° C. to obtain resin particle dispersion 1 containing resin particle 1a. The particle diameter of the resin particle 1a of resin particle dispersion 1 was measured using electrophoresis light scattering photometer ELS-800 (produced by OTSUKA DENSHI CO.) and the volume-based median diameter was determined to be 150 nm. Further, the glass transition temperature of resin particle 1a was 45° C.

### [Preparation Examples of Resin Particle Dispersions 2-8]

Each of Resin particle dispersions 2-8 was obtained similarly to preparation example of resin particle dispersion 1, except that each of the corresponding releasing agents shown in Table 1 was employed.

### [Preparation Example of Colorant Particle Dispersion Q]

While stirring, 59.0 g of anionic surfactant was dissolved in 1600 ml of ion-exchange water. A colorant was added while stirring this solution, and a dispersing treatment was subsequently conducted employing a dispersing device (SC Mill, manufactured by Mitsui Mining Co., Ltd.) to prepare colorant particle dispersion Q. The volume-based average colorant particle diameter of this colorant dispersion was measured to be 150 nm using a dynamic light scattering particle size analyzer (Microtrac UPA150, manufactured by Nikkiso Co., Ltd.).

### [Preparation Example of Toner Particle 1]

Into a 5 liter reaction vessel fitted with a stirrer, a temperature sensor, a condenser and a nitrogen gas introducing device, charged was a solution in which resin particle dispersion 1 at a solid content of 300 g, 1400 g of ion-exchange water, 120 g of colorant particle dispersion Q and 3 g of polyoxyethylene 2-dodecyl ether sodium sulfate were dissolved in 120 ml of ion-exchange water, and after adjusted to a liquid temperature of 30° C., the pH was adjusted to 10 with 5 mol/liter of an aqueous sodium hydroxide solution. Subsequently, an aqueous solution of 35 g of magnesium chloride dissolved in 35 ml of ion-exchange water was added thereto at 30° C. over 10 min. with stirring. After being maintained for 3 min., the temperature was raised to 90° C. over 60 min. and maintained at 90° C. to promote particle growth reaction. While measuring coagulated particle diameters using Coulter Multicizer III and when reached the intended particle diameter, an aqueous solution of 150 g of sodium chloride dissolved in 600 ml of ion-exchange water was added thereto to terminate particle growth. Further, ripening is performed at 98° C. with stirring to promote fusion between particles until reached an average circularity of 0.965, allowing hydrophobic resin to orient toward the surface side of the coagulated particles and hydrophilic resin to orient toward the interior side of the coagulated particles to form toner particles having a core/shell structure. Then, cooling was conducted until reached 30° C. and the pH was adjusted to 4.0 with hydrochloric acid and stirring was terminated.

The thus formed toner particles were subjected to solid/liquid separation by using a basket type centrifugal separator, MARK III type No. 60×40 (produced by Matsumoto Kikai Co., Ltd.) to form a wet cake of the toner particles. The wet cake was washed with 45° C. ion-exchange water by using the basket type centrifugal separator until the filtrate reached an electric conductivity of 5 μS/cm, transferred to Flash Jet Dryer (produced by Seishin Enterprise Co., Ltd.) and dried until reached a moisture content of 0.5% by weight to obtain particle used for a toner.

To the resulting particles, hydrophobic silica (number average primary particle diameter of 12 nm) and hydrophobic titania (number average primary particle diameter of 20 nm) were added in amounts of 1% by weight and 0.3% by weight, respectively, and mixed in a Henschel mixer to prepare toner particle 1. The toner particles were not varied by addition of hydrophobic silica or hydrophilic titanium oxide, with respect to shape or particle diameter.

### [Preparation Examples of Toner Particles 2-8]

Each of toner particles 2-8 was prepared similarly to preparation example of toner particle 1, except that resin particle dispersion 1 was replaced by each of corresponding resin particle dispersions 2-8.

### [Preparation of Developers 1-8]

Each of the toner particles 1-8 was mixed with a silicone resin-coated ferrite carrier exhibiting a volume-based average particle diameter of 60 μm so as to set a toner content to 6% to prepare each of developers 1-5 from each of corresponding toner particles 1-5, and each of comparative developers 1-3 from each of corresponding toner particles 6-8.

### [Evaluation]

The thus prepared developers 1-5 and comparative developers 1-2 were each subjected to practical picture tests using a digital copier, bizhub PRO C350 (manufactured by Konica Minolta Business Technologies, Inc) which was installed with the fixing device as described below and evaluated according to the following items (I) to (II). Results are shown in Table 2.

### [Fixing Device]

A heating roller comprised of a cylindrical aluminum alloy core (inside diameter of 40 mm, wall thickness of 1.0 mm, and total width of 310 mm), the surface of which was covered with 120 μm thick PTFE (tetrafluoroethylene) and having a heater in the central portion, and a pressure roller comprised of a cylindrical iron core (having an inside diameter of 40 mm and a wall thickness of 2.0 mm), the surface of which was covered with silicone sponge rubber (exhibiting an Asker C hardness of 48° and having a thickness of 2.0 mm) were placed in contact with each other under a total load of 150N, forming a 5.8 mm wide fixing nip portion. The fixing device was used at a linear printing speed of 160 mm/sec, while controlling the fixing temperature at 120° C., 140° C. or 160° C.

### (I) Image Unevenness

Under an environment of ordinary temperature and humidity (20° C., 55% RH), mixed images having a picture element ratio of 76, a portrait photographic image and a solid cyan image having a relative image density of 1.2, formed on J Paper of 64 g/m² (manufactured by Konica Minolta Business Technologies, Inc.) were printed as a test image while maintaining the fixing belt temperature at 120° C., 140° C. or 160° C. The resulting test image was visually observed with respect to image unevenness and evaluated based on the following criteria:

A: no image unevenness was observed.

B: Image unevenness was slightly observed.

C: Image unevenness was observed, but acceptable in practical use.

D: Image unevenness was clearly observed, and unacceptable in practical use.

### (II) Separability in Fixing

Under an environment of ordinary temperature and humidity (20° C., 55% RH), the surface temperature of a heating roller was controlled to 120° C., 140° C. or 160° C. and an A4 image having a solid black banded image of a 5 mm width vertical to the transport direction was formed on a A4 size fine-quality paper (64 g/m²) and transported in the machine direction. Separability of the paper from the image side of the heating roller was evaluated, based on the following criteria:

A: The paper is separated from the heating roller without curling the A4 fine-paper.

B: The A4 fine-paper is separable from the heating roller by a separating claw but a separating claw mark is hardly noticeable.

C: The A4 fine-paper is separable from the heating roller by a separating claw, and the separating claw mark remains on an image, but this is acceptable in practical use.

D: No separating claw mark is substantially used any more, or the A4 paper is wound around the heating roller and not separable therefrom.

TABLE 2

| | Releasing | Image | | | Separability | | | |
|---|---|---|---|---|---|---|---|---|
| Developer | agent | unevenness | | | in fixing | | | |
| No. | No. | 120° C. | 140° C. | 160° C. | 120° C. | 140° C. | 160° C. | Remarks |
| Developer 1 | 1 | A | B | C | A | A | A | Present |
| | | | | | | | | invention |
| Developer 2 | 2 | A | A | A | B | A | A | Present |
| | | | | | | | | invention |
| Developer 3 | 3 | A | A | A | A | A | A | Present |
| | | | | | | | | invention |
| Developer 4 | 4 | A | A | A | A | B | A | Present |
| | | | | | | | | invention |
| Developer 5 | 5 | A | A | A | C | B | A | Present |
| | | | | | | | | invention |
| Comparative | 6 | C | D | D | A | A | A | Comparative |
| developer 1 | | | | | | | | example |
| Comparative | 7 | A | A | A | D | D | C | Comparative |
| developer 2 | | | | | | | | example |
| Comparative | 8 | A | A | A | D | D | D | Comparative |
| developer 3 | | | | | | | | example |

As is clear from Table 2, it was realized that examples 1-5 relating to the toner of the present invention exhibited no image unevenness, together with superior separability (releasing capability) from the transfer material.

### EFFECT OF THE INVENTION

An electrostatic charge image developing toner capable of obtaining clear prints with no image unevenness, together with a maintained low temperature fixing property at low cost can be obtained in the present invention, whereby the clear prints with no image unevenness are able to be acquired without forming a transparent toner layer at a high price to largely produce cost-effectiveness for users.

What is claimed is:

1. An electrostatic charge image developing toner comprising toner particles each containing at least a binder resin, a colorant and wax,
wherein a ratio {(S1/S)×100} of total area (S1) of peaks detected in a range of 36-42 ppm to total area (S) of peaks detected in a range of 0-50 ppm, in a spectrum obtained via measurement of the wax employing a 13C-NMR (nuclear magnetic resonance) measuring apparatus, satisfies the following inequality.
0.03≦(S1/S)×100≦0.50

2. The electrostatic charge image developing toner of claim 1,
wherein the ratio {(S1/S)×100} satisfies the following inequality.
0.05≦(S1/S)×100≦0.30

3. The electrostatic charge image developing toner of claim 1,
wherein the wax is hydrocarbon based wax.

4. The electrostatic charge image developing toner of claim 2,
wherein the wax is hydrocarbon based wax.
